(19) United States
(12) Patent Application Publication
(10) Pub. No.: US 2026/0229764 A1
(43) Pub. Date: Aug. 6, 2026

(54) DIELECTRIC RESONATOR, DIELECTRIC FILTER, AND COMMUNICATION DEVICE

(71) Applicant: HUAWEI TECHNOLOGIES CO., LTD., Shenzhen (CN)

(72) Inventors: Dongchun Qiao, Shanghai (CN); Guosheng Pu, Yokohama (JP)

(21) Appl. No.: 19/643,968

(22) Filed: Apr. 10, 2026

Related U.S. Application Data
(63) Continuation of application No. PCT/CN2024/112843, filed on Aug. 16, 2024.

(30) Foreign Application Priority Data
Oct. 12, 2023 (CN) 202311324279.4

(51) Int. Cl. H01P 7/10; H01P 1/20

(52) U.S. Cl. CPC H01P 7/10; H01P 1/2002

(57) ABSTRACT

A dielectric resonator, dielectric filter, and communication device. The dielectric resonator includes a first dielectric block, a second dielectric block, a first conductive layer, and a second conductive layer. The first dielectric block has a mounting hole, and the second dielectric block is located in the mounting hole. A dielectric constant of the second dielectric block is greater than a dielectric constant of the first dielectric block. The first conductive layer is located on at least a portion of a surface of the first dielectric block other than a surface opposite to the second dielectric block. The second conductive layer is located on at least a portion of a surface of the second dielectric block other than a surface opposite to the first dielectric block. The second conductive layer is coupled to the first conductive layer.

### CROSS-REFERENCE TO RELATED APPLICATIONS

This application is a continuation of International Application No. PCT/CN2024/112843, filed on Aug. 16, 2024, which claims priority to Chinese Patent Application No. 202311324279.4, filed on Oct. 12, 2023. The disclosures of the aforementioned applications are hereby incorporated by reference in their entireties.

### TECHNICAL FIELD

This application relates to the field of communication technologies, and in particular, to a dielectric resonator, a dielectric filter, and a communication device.

### BACKGROUND

The push for carbon neutrality has imposed stricter power consumption requirements on base stations. As a key component in base stations, filters significantly affect power consumption of the base stations. Dielectric filters are widely used in the base stations due to their excellent performance and size advantages.

Dielectric filters generally fall into two categories: single-mode and multi-mode (such as dual-mode or tri-mode dielectric filters). These filters are typically constructed from dielectric resonators. Although multi-mode dielectric filters offer a high quality factor (Q value), their relatively large size and the difficulty of miniaturization make them less suitable for the ongoing trend of base station size reduction. Single-mode dielectric filters, on the other hand, are better aligned with miniaturization requirements, but achieving a high Q value remains challenging. In view of this, how to provide a dielectric filter with a high Q value has become a pressing technical challenge in this field.

### SUMMARY

Embodiments of this application provide a dielectric resonator, a dielectric filter, and a communication device, aiming to improve a quality factor of the dielectric resonator and provide a dielectric filter with a high Q value.

To achieve the foregoing objectives, the following technical solutions are used in embodiments of this application.

According to a first aspect, a dielectric resonator is provided, where the dielectric resonator includes a first dielectric block, a second dielectric block, a first conductive layer, and a second conductive layer. The first dielectric block has a mounting hole, and the second dielectric block is located in the mounting hole; and a dielectric constant of the second dielectric block is greater than a dielectric constant of the first dielectric block. The first conductive layer is located on at least a portion of a surface of the first dielectric block other than a surface opposite to the second dielectric block. The second conductive layer is located on at least a portion of a surface of the second dielectric block other than a surface opposite to the first dielectric block. The second conductive layer is coupled to the first conductive layer.

According to the dielectric resonator provided in this embodiment of this application, the first dielectric block includes a mounting hole, the second dielectric block is located in the mounting hole, and the dielectric constant of the second dielectric block is greater than the dielectric constant of the first dielectric block. A higher dielectric constant indicates a strong ability to confine an electric field. Consequently, during operation of the dielectric resonator, an electric field in the dielectric resonator may be concentrated in the second dielectric block, inducing a current therein. Due to the inherent high Q value characteristic of dielectric materials, the second dielectric block has a relatively small impedance. As the induced current flows through the second dielectric block, a loss generated by the dielectric resonator 300 may be relatively small, thereby effectively increasing the Q value of the dielectric resonator 300.

Simulation tests have shown that, when a height or a diameter (or a length or a width) is increased, the Q value of the dielectric resonator provided in this embodiment of this application may change greatly. This means the Q value can be effectively increased by adjusting the height or the diameter (or the length or the width), making it less difficult to increase the Q value of the dielectric resonator provided in this embodiment of this application. In this way, the dielectric resonator provided in this embodiment of this application not only achieves a high Q value, but also offers tunability for even a higher Q value by adjusting a size of the dielectric resonator. This makes the dielectric resonator suitable for a scenario demanding medium or high power or stringent loss requirements. This effectively improves applicability of the dielectric resonator.

In some embodiments, the first dielectric block includes an annular part, the annular part is disposed around a periphery of the second dielectric block, and there is a gap between the annular part and the second dielectric block.

In this embodiment of this application, by providing a gap between the annular part and the second dielectric block, it facilitates the insertion of the second dielectric block into the mounting hole (the annular part), avoiding a case in which the second dielectric block cannot be placed in the mounting hole (the annular part) due to a process error. In addition, the gap can be leveraged to adjust a high-order mode of the dielectric resonator. By improving the high-order mode of the dielectric resonator, interference frequency bands, such as second and third harmonics, can be more effectively suppressed, thereby improving performance of the dielectric resonator.

In some embodiments, the dielectric resonator further includes a fastening structure, located in the gap and connecting the annular part to the second dielectric block.

In this embodiment of this application, the fastening structure is disposed in the gap and the fastening structure connects the annular part to the second dielectric block. This fastening structure secures a relative position relationship between the annular part and the second dielectric block, preventing relative movement between the second dielectric block and the annular part that could cause damage to the second dielectric block and the annular part and interrupt normal operation of the dielectric resonator.

In some embodiments, the fastening structure includes an adhesive layer and a third conductive layer. The adhesive layer is adhered to opposite surfaces of the annular part and the second dielectric block, and a material of the adhesive layer is an insulating material. The third conductive layer is located on a surface of the adhesive layer other than a surface connecting the annular part and the second dielectric block. The third conductive layer connects the first conductive layer and the second conductive layer.

In this embodiment of this application, the fastening structure includes the adhesive layer and the third conductive layer. The adhesive layer connects the annular part to the second dielectric block, preventing relative movement between the second dielectric block and the annular part that could cause damage to the second dielectric block and the annular part and interrupt normal operation of the dielectric resonator. In addition, the third conductive layer connects the first conductive layer and the second conductive layer, helping simplify a structure of the dielectric resonator and reduce costs.

In some embodiments, a dielectric constant of the adhesive layer is less than the dielectric constant of the first dielectric block.

In this embodiment of this application, the dielectric constant of the adhesive layer is less than the dielectric constant of the first dielectric block, and the dielectric constant of the first dielectric block is less than the dielectric constant of the second dielectric block. This creates a large difference between the dielectric constant of the adhesive layer and the dielectric constant of the second dielectric block. Since the second dielectric block is in direct contact with the adhesive layer, the dielectric resonator exhibits a relatively high high-order mode during operation. This helps further filter out interference frequencies such as second and third harmonics of the resonance frequency, thereby improving performance of the dielectric resonator.

In some embodiments, at at least one end in an extension direction of the mounting hole, the adhesive layer is coplanar with the annular part and the second dielectric block.

In the dielectric resonator provided in this embodiment of this application, at at least one end in the extension direction of the mounting hole, the adhesive layer is coplanar with the annular part and the second dielectric block. This facilitates coupling between the third conductive layer located on the adhesive layer, the first conductive layer located on the annular part, and the second conductive layer located on the second dielectric block, thereby helping simplify a structure of the dielectric resonator.

In some embodiments, the second dielectric block is provided with a blind hole at at least one end in the extension direction of the mounting hole.

In this embodiment of this application, the second dielectric block is provided with the blind hole at one end in the extension direction of the mounting hole. This blind hole can be used to fine-tune a resonance frequency of the dielectric resonator after the dielectric resonator is prepared, thereby increasing manufacturing field of the dielectric resonator. For example, the resonance frequency of the dielectric resonator may be fine-tuned by grinding the second conductive layer on a bottom wall of the blind hole.

In some embodiments, the dielectric resonator further includes a first conductive cover, the first conductive cover is located on one side of the second dielectric block in the extension direction of the mounting hole, and the first conductive cover connects the first conductive layer and the second conductive layer.

In the dielectric resonator provided in this embodiment of this application, the first conductive cover is disposed on one side of the second dielectric block in the extension direction of the mounting hole. The first conductive cover electrically connects the first conductive layer and the second conductive layer, while securing a relative position relationship between the first dielectric block and the second dielectric block. This helps enhance structural stability and manufacturing yield of the dielectric resonator provided in this embodiment of this application.

In some embodiments, when a blind hole is provided at an end that is of the second dielectric block and that is close to the first conductive cover, the first conductive cover includes a first opening, and the blind hole is exposed from the first opening. In this way, it is convenient to subsequently adjust a frequency of the dielectric resonator by using the blind hole.

In some embodiments, the dielectric resonator further includes a second conductive cover, the second conductive cover is located on the other side of the second dielectric block in the extension direction of the mounting hole, and the second conductive cover connects the first conductive layer and the second conductive layer.

In the dielectric resonator provided in this embodiment of this application, the second conductive cover is disposed on the other side of the second dielectric block in the extension direction of the mounting hole. Both the first conductive cover and the second conductive cover electrically connect the first conductive layer and the second conductive layer, and while securing the relative position relationship between the first dielectric block and the second dielectric block. This further helps enhance the structural stability and manufacturing yield of the dielectric resonator provided in this embodiment of this application.

In some embodiments, when a blind hole is provided at an end that is of the second dielectric block and that is close to the second conductive cover, the second conductive cover includes a second opening, and the blind hole is exposed from the second opening. In this way, it is convenient to subsequently adjust the frequency of the dielectric resonator 300 by using the blind hole.

In some embodiments, the first dielectric block further includes a block-shaped part connected to the annular part, and the block-shaped part covers an opening at an end of the mounting hole.

In this embodiment of this application, although the mounting hole is a blind hole, the absence of a conductive layer on a hole wall of the mounting hole avoids a significant loss typically associated with current flowing through plated blind holes in conventional designs. In the dielectric resonator provided in this embodiment of this application, the second conductive block that is located in the mounting hole and that has a higher dielectric constant may concentrate more electric fields in the dielectric resonator in the second dielectric block, to generate an induced current in the second dielectric block. Due to the inherent high Q value characteristic of dielectric materials, the second dielectric block has a relatively small impedance. As the induced current flows through the second dielectric block, a loss generated by the dielectric resonator may be relatively small, thereby effectively increasing the Q value of the dielectric resonator.

In some embodiments, an axis of the mounting hole coincides with an axis of the second dielectric block.

In this way, the second dielectric block may be located at a central position of the mounting hole, allowing more electric fields to be concentrated in the second dielectric block. This further reduces a loss of the dielectric resonator and increases the Q value of the dielectric resonator. In addition, locating the second dielectric block at the central position of the mounting hole helps achieve a more uniform magnetic field distribution outside the first dielectric block, thereby improving performance of the dielectric resonator.

According to a second aspect, a dielectric filter is provided, where the dielectric filter includes the dielectric resonator according to any one of the foregoing embodiments.

In some embodiments, the dielectric filter may be used in an active antenna element.

In some embodiments, the dielectric filter may be used in a radio remote unit.

According to a third aspect, a communication device is provided. The electronic device includes the dielectric filter according to any one of the foregoing embodiments. A chip is located on a circuit board and is electrically connected to the circuit board.

For technical effects brought in by any design manner in the second aspect and the third aspect, refer to technical effects brought in by different design manners in the first aspect. Details are not described herein again.

### BRIEF DESCRIPTION OF DRAWINGS

To describe technical solutions in this application more clearly, the following briefly describes accompanying drawings used for describing some embodiments of this application. It is clear that the accompanying drawings in the following descriptions are merely accompanying drawings in some embodiments of this application. A person of ordinary skill in the art may further derive other drawings from these accompanying drawings. In addition, the accompanying drawings in the following descriptions may be considered as diagrams, and are not intended to limit an actual size of a product, an actual procedure of a method, an actual timing of a signal, and the like in embodiments of this application.

FIG. 1 is a diagram of a structure of a dielectric resonator according to an embodiment of this application;

FIG. 2 is another diagram of a structure of a dielectric resonator according to an embodiment of this application;

FIG. 3 is a side view of the dielectric resonator provided in FIG. 2;

FIG. 4 is a curve diagram of a relationship between a resonance frequency and a depth according to an embodiment of this application;

FIG. 5 is a diagram of a structure of a dielectric resonator according to an embodiment of this application;

FIG. 6 is a curve diagram of a relationship between a Q value and a diameter according to an embodiment of this application;

FIG. 7 is a curve diagram of a relationship between a Q value and a height according to an embodiment of this application;

FIG. 8 is another diagram of a structure of a dielectric resonator according to an embodiment of this application;

FIG. 9 is another diagram of a structure of a dielectric resonator according to an embodiment of this application;

FIG. 10 is a diagram of a three-dimensional structure of a dielectric resonator according to an embodiment of this application;

FIG. 11 is another diagram of a structure of a dielectric resonator according to an embodiment of this application;

FIG. 12 is another diagram of a structure of a dielectric resonator according to an embodiment of this application;

FIG. 13 is another diagram of a three-dimensional structure of a dielectric resonator according to an embodiment of this application;

FIG. 14 is another diagram of a structure of a dielectric resonator according to an embodiment of this application;

FIG. 15 is an exploded diagram of a dielectric resonator according to an embodiment of this application;

FIG. 16 is another diagram of a structure of a dielectric resonator according to an embodiment of this application;

FIG. 17 is a diagram of a structure of an active antenna element according to an embodiment of this application; and

FIG. 18 is a diagram of a structure of a radio remote unit according to an embodiment of this application.

### DESCRIPTION OF EMBODIMENTS

The following describes the technical solutions in embodiments of this application with reference to the accompanying drawings in embodiments of this application. It is clear that the described embodiments are merely a part rather than all of embodiments of this application.

Terms such as “first” and “second” mentioned below in embodiments of this application are merely used for ease of description, and shall not be understood as an indication or implication of relative importance or implicit indication of a quantity of indicated technical features. Therefore, a feature limited by “first”, “second”, or the like may explicitly or implicitly include one or more features. In the descriptions of this application, unless otherwise stated, “a plurality of” means two or more than two.

In embodiments of this application, “up”, “down”, “left”, and “right” are not limited to definitions relative to directions in which components are schematically placed in accompanying drawings. It should be understood that these directional terms may be relative concepts used for relative description and clarification, and may change correspondingly based on a change of a direction in which a component in an accompanying drawing is placed.

In embodiments of this application, unless otherwise specified in the context, in the entire specification and claims, the term “include” is interpreted as “open and inclusive”, that is, “include, but not limited to”. In the descriptions of the specification, terms such as “an embodiment”, “some embodiments”, “example embodiments”, “examples”, or “some examples” are intended to indicate that specific features, structures, materials, or features related to embodiments or examples are included in at least one embodiment or example of the present disclosure. The foregoing schematic representations of the terms do not necessarily refer to a same embodiment or example. Further, the particular feature, structure, material, or characteristic may be included in any one or more embodiments or examples in any appropriate manner.

When some embodiments are described, expressions of “coupling” and its extensions may be used. For example, when some embodiments are described, the term “coupling” may indicate that two or more components are in direct physical contact or electrical contact. However, the term “coupling” may also indicate that two or more components in direct contact with each other, but still collaborate or interact with each other. Embodiments disclosed herein are not necessarily limited to content of this specification.

In embodiments of this application, an example implementation is described with reference to a sectional view and/or a plane diagram and/or an equivalent circuit diagram that are/is used as idealized example accompanying drawings. In the accompanying drawings, for clarity, thicknesses of layers and regions are increased. Thus, a change in a shape in the accompanying drawings due to, for example, manufacturing techniques and/or tolerances may be envisaged. Therefore, example implementations should not be construed as being limited to a shape of a region shown herein, but rather include shape deviations due to, for example, manufacturing. For example, an etching region shown as a rectangle typically has a bending feature. Therefore, the regions shown in the accompanying drawings are essentially examples, and their shapes are not intended to show actual shapes of regions of a device, and are not intended to limit a scope of the example implementations.

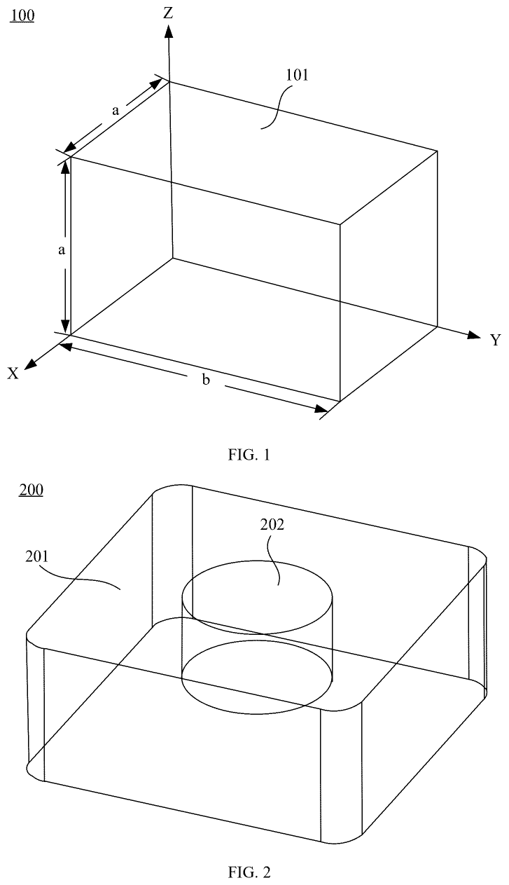

FIG. 1 shows a multi-mode dielectric resonator 100. The multi-mode dielectric resonator 100 includes a dielectric block 101, and no loading structure (for example, a blind hole) is disposed on the dielectric block 101. In this case, the multi-mode dielectric resonator 100 is rectangular, a coordinate system is established at a vertex of the multi-mode dielectric resonator, a size (namely, a height) of the multi-mode dielectric resonator 100 in a Z-axis direction is a, a size (namely, a width) of the multi-mode dielectric resonator 100 in an X-axis direction is a, and a size (namely, a length) of the multi-mode dielectric resonator in a Y-axis direction is b.

A formula for calculating a resonance frequency of the multi-mode dielectric resonator 100 may be

$${f}_{101} = \frac{1}{2 \sqrt{{με}_{r} {ε}_{0}}} \sqrt{{( \frac{1}{a} )}^{2} + {( \frac{1}{b} )}^{2}} .$$

Herein, f₁₀₁ is the resonance frequency, u is a magnetic permeability, εᵣ is a relative dielectric constant, and co is an absolute dielectric constant.

A quality factor (Q value) of the multi-mode dielectric resonator 100 is high. For example, in a simulation test, when a dielectric constant of the dielectric block 101 is 20, a height and a width of the dielectric block 101 are both 12 millimeters, and a length of the dielectric block 101 is 15 millimeters, the Q value of the multi-mode dielectric resonator 100 may reach 2500.

However, the resonance frequency of the multi-mode dielectric resonator 100 is determined by the height (or width) and length of the multi-mode dielectric resonator 100 and the dielectric constant. The resonance frequency of the multi-mode dielectric resonator 100 also determines the height (or width) and length of the multi-mode dielectric resonator 100, and therefore, the multi-mode dielectric resonator 100 is not easy to be miniaturized. In addition, the resonance frequency is greatly affected by an appearance size, and the frequency is sensitive to a change of the appearance size. As a result, the multi-mode dielectric resonator 100 has a high appearance requirement, and is difficult to be prepared.

FIG. 2 is a diagram of a structure of a single-mode dielectric resonator 200. The single-mode dielectric resonator 200 includes a dielectric block 201, and a plated blind hole 202 is provided in the dielectric block 201.

The single-mode dielectric resonator 200 may be miniaturized by providing the plated blind hole 202 in the dielectric block 201. The plated blind hole herein may be understood as a blind hole whose surface or hole wall is covered with a metal layer, or a blind hole whose hole wall is covered with a metal layer. Specifically, frequency compression may be implemented by using capacitance between a bottom of the plated blind hole 202 and a lower surface of the dielectric block 201, thereby achieving miniaturization.

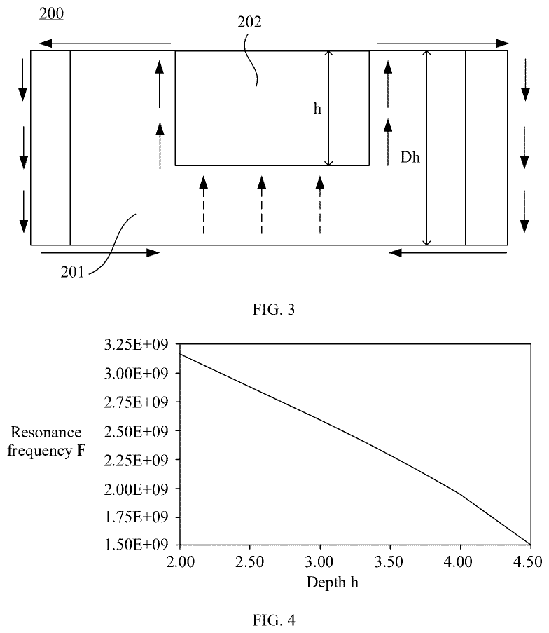

FIG. 3 is a side view of the single-mode dielectric resonator 200 shown in FIG. 2. Herein, h represents a depth of the plated blind hole 202, and Dh represents a height of the dielectric block 201. A resonance frequency may be adjusted by adjusting the depth h of the plated blind hole 202. For example, FIG. 4 is a diagram showing that a resonance frequency F changes with the depth h (unit: millimeter). It can be learned from FIG. 4 that a larger value of the depth h of the plated blind hole 202 indicates a lower resonance frequency F. In other words, a closer proximity between the depth h of the blind hole and the height Dh of the dielectric block indicates a lower resonance frequency.

Although the single-mode dielectric resonator 200 can adjust the resonance frequency by adjusting the depth of the plated blind hole 202, to be used in a wide frequency band range, the single-mode dielectric resonator 200 may also adapt to development of miniaturization of a communication device like a base station. However, an upper limit of the Q value of the single-mode dielectric resonator 200 is low, and it is difficult to increase the Q value. In a working scenario in which a high power can be used, there are problems such as a large amount of generated heat, and it is difficult to meet a scenario with a high loss requirement.

FIG. 3 shows distribution of currents in the single-mode dielectric resonator 200 in a working process according to a related technology. A dashed line arrow represents an induced current, and a solid line arrow represents a conducted current. The inventor of this application finds through research that, in the working process of the single-mode dielectric resonator 200, a conducted current flowing through a side wall of the plated blind hole is large. However, due to a limitation of a preparation process, metal layers in the plated blind hole exhibit poor uniformity and low conductivity. As a result, when the current flows through the plated blind hole, impedance generated by the single-mode dielectric resonator 200 is also large, thereby affecting the Q value of the dielectric resonator.

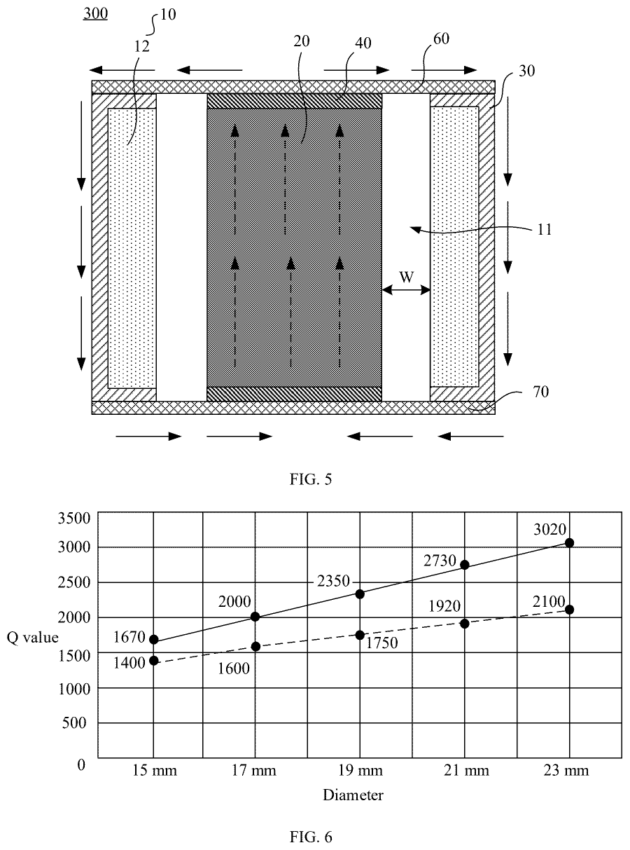

In view of this, an embodiment of this application provides a dielectric resonator. FIG. 5 is a diagram of a structure of a dielectric resonator 300 according to an embodiment of this application.

As shown in FIG. 5, the dielectric resonator 300 may include a first dielectric block 10, a second dielectric block 20, a first conductive layer 30, and a second conductive layer 40. The first dielectric block 10 has a mounting hole 11, and the second dielectric block 20 is located in the mounting hole 11. A dielectric constant of the second dielectric block 20 is greater than a dielectric constant of the first dielectric block 10.

The first conductive layer 30 is located on at least a portion of a surface of the first dielectric block 10 other than a surface opposite to the second dielectric block 20. The second conductive layer 40 is located on at least a portion of a surface of the second dielectric block 20 other than a surface opposite to the first dielectric block 10. The second conductive layer 40 is coupled to the first conductive layer 30.

For example, the dielectric constant of the first dielectric block 10 may range from 10 to 20, and the dielectric constant of the second dielectric block 20 may range from 45 to 65.

That “the second dielectric block 20 is located in the mounting hole 11” may mean that the second dielectric block 20 may be completely located in the mounting hole 11, or may mean that a portion of the second dielectric block 20 is located in the mounting hole 11, and another portion of the second dielectric block 20 extends out of the mounting hole 11.

For example, the first conductive layer 30 may cover all of a surface of the first dielectric block 10 other than the surface opposite to the second dielectric block 20. Alternatively, the first conductive layer 30 may cover a portion of the surface of the first dielectric block 10 other than the surface opposite to the second dielectric block 20.

Similarly, the second conductive layer 40 may cover all of a surface of the second dielectric block 20 other than the surface opposite to the first dielectric block 10. Alternatively, the second conductive layer 40 may cover a portion of the surface of the second dielectric block 20 other than the surface opposite to the first dielectric block 10.

The foregoing “the second conductive layer 40 is coupled to the first conductive layer 30” includes both a case in which the second conductive layer 40 is in direct contact with the first conductive layer 30 and a case in which the second conductive layer 40 is in indirect contact with the first conductive layer 30.

For example, materials of the first conductive layer 30 and the second conductive layer 40 may include metals such as silver and copper.

In some possible implementations, the material of the first conductive layer 30 may be the same as the material of the second conductive layer 40. In this case, the first conductive layer 30 and the second conductive layer 40 may be prepared at the same time. This helps simplify a preparation process of the dielectric resonator 300, reduce costs, and improve preparation efficiency.

In some other possible implementations, the material of the first conductive layer 30 may alternatively be different from the material of the second conductive layer 40.

Neither a thickness of the first conductive layer 30 nor a thickness of the second conductive layer 40 is limited in embodiments of this application, and may be designed according to an actual requirement. The thickness of the first conductive layer 30 is a film thickness of the first conductive layer 30, namely, a distance from a surface that is of the first conductive layer 30 and that is away from the first dielectric block 10 to a surface that is of the first conductive layer 30 and that is close to the first dielectric block 10. Similarly, the thickness of the second conductive layer 40 is a film thickness of the second conductive layer 40, namely, a distance from a surface that is of the second conductive layer 40 and that is away from the second dielectric block 20 to a surface that is of the second conductive layer 40 and that is close to the second dielectric block 20.

For example, the thickness of the first conductive layer 30 may range from 2 micrometers to 7 micrometers. For example, the thickness of the first conductive layer 30 may be 2 micrometers, 3 micrometers, 4 micrometers, 5 micrometers, 6 micrometers, or 7 micrometers. In this way, the thickness of the first conductive layer 30 is not excessively small, so that the first conductive layer 30 is not easily detached from the first dielectric block 10, and the first conductive layer 30 is not easily missing due to abrasion either. This effectively ensures performance of the dielectric resonator 300. In addition, the thickness of the first conductive layer 30 is not excessively large, thereby helping reduce costs.

For example, the thickness of the second conductive layer 40 may range from 2 micrometers to 7 micrometers. For example, the thickness of the second conductive layer 40 may be 2 micrometers, 3 micrometers, 4 micrometers, 5 micrometers, 6 micrometers, or 7 micrometers. In this way, the thickness of the second conductive layer 40 is not excessively small, so that the second conductive layer 40 is not easily detached from the second dielectric block 20, and the first conductive layer 30 is not easily missing due to abrasion either. This effectively ensures performance of the dielectric resonator 300. In addition, the thickness of the second conductive layer 40 is not excessively large, thereby helping reduce costs.

FIG. 5 shows distribution of currents in a working process of the dielectric resonator 300 according to an embodiment of this application. A dashed arrow also represents an induced current, and a solid arrow also represents a conducted current. As shown in FIG. 5, the conducted current is transmitted on the first conductive layer 30 and the second conductive layer 40.

In the dielectric resonator 300 provided in this embodiment of this application, the first dielectric block 10 includes the mounting hole 11, the second dielectric block 20 is located in the mounting hole 11, and the dielectric constant of the second dielectric block 20 is greater than the dielectric constant of the first dielectric block 10. A higher dielectric constant indicates a strong ability to confine an electric field. Consequently, during operation of the dielectric resonator 300, an electric field in the dielectric resonator 300 may be concentrated in the second dielectric block 20, inducing a current in the second dielectric block 20. Due to the inherent high Q value characteristic of dielectric materials, the second dielectric block 20 has a relatively small impedance. As the induced current flows through the second dielectric block 20, in comparison with a solution provided in a related technology, a loss generated by the dielectric resonator 300 may be relatively small, thereby effectively increasing the Q value of the dielectric resonator 300.

For example, the dielectric resonator provided in this embodiment of this application is integrally in a cylinder shape, and the dielectric resonator provided in the related technology is also integrally in a cylinder shape. FIG. 6 shows a curve (shown by a solid line) of a relationship between a Q value of the dielectric resonator provided in this embodiment of this application and a diameter of the dielectric resonator, and a curve (shown by a dashed line) of a relationship between a Q value of the dielectric resonator provided in the related technology and a diameter of the dielectric resonator. FIG. 7 shows a curve (shown by a solid line) of a relationship between a Q value of the dielectric resonator provided in this embodiment of this application and a height of the dielectric resonator, and a curve (shown by a dashed line) of a relationship between a Q value of the dielectric resonator provided in the related technology and a height of the dielectric resonator.

It can be learned from FIG. 6 that, when the diameters are the same, the Q value of the dielectric resonator provided in this embodiment of this application is higher than the Q value of the dielectric resonator provided in the related technology. In addition, when the same diameter is increased, a variation of the Q value of the dielectric resonator provided in this embodiment of this application is also greater than a variation of the Q value of the dielectric resonator provided in the related technology.

Similarly, it can be learned from FIG. 7 that, when the heights are the same, the Q value of the dielectric resonator provided in this embodiment of this application is higher than the Q value of the dielectric resonator provided in the related technology. When the same height is increased, a variation of the Q value of the dielectric resonator provided in this embodiment of this application is also greater than a variation of the Q value of the dielectric resonator provided in the related technology.

It can be learned that, when a height or a diameter (or a length or a width) is increased, the Q value of the dielectric resonator 300 provided in this embodiment of this application may change greatly. This means the Q value can be effectively increased by adjusting the height or the diameter (or the length or the width), making it less difficult to increase the Q value of the dielectric resonator 300 provided in this embodiment of this application. In this way, the dielectric resonator 300 provided in this embodiment of this application not only achieves a high Q value, but also offers tunability for even a higher Q value by adjusting a size of the dielectric resonator 300. This makes the dielectric resonator 300 suitable for a scenario demanding medium or high power or stringent loss requirements. This effectively improves applicability of the dielectric resonator 300.

In some embodiments, the second dielectric block 20 may be in a cylinder shape. In this case, symmetric in structure of the second dielectric block 20 is symmetric in structure helps achieve a more uniform electric field distribution in the second dielectric block 20, thereby further reducing a loss and increasing the Q value.

In some embodiments, as shown in FIG. 5, the first dielectric block 10 includes an annular part 12, the annular part 12 is disposed around a periphery of the second dielectric block 20, and there is a gap W between the annular part 12 and the second dielectric block 20.

Certainly, a shape of a cross section of the annular part 12 is not limited to a circular ring, a square ring, or the like. The annular part 12 may be any structure that can be formed into a circle through enclosing, or may be a structure having a through hole. It may be understood that, when the first dielectric block 10 includes the annular part 12, the mounting hole 11 is used as a through hole of the annular part 12.

In some examples, the annular part 12 may be a hollow cylinder.

The gap between the annular part 12 and the second dielectric block 20 may be that there is a gap between the annular part 12 and the second dielectric block 20 everywhere, or may be that a portion of opposite surfaces of annular part 12 and the second dielectric block 20 are in contact, and there is a gap between another portion of opposite surfaces of the annular part 12 and the second dielectric block 20.

A size of the gap W is not limited in embodiments of this application, and may be designed according to an actual requirement. For example, at different positions of the dielectric resonator 300, sizes of the gap W between the annular part 12 and the second dielectric block 20 may be different.

In this embodiment of this application, the gap W is provided between the annular part 12 and the second dielectric block 20, facilitating the insertion of the second dielectric block 20 into the mounting hole 11 (the annular part 12), avoiding a case in which the second dielectric block 20 cannot be placed in the mounting hole 11 (the annular part 12) due to a process error. In addition, the gap W can be leveraged to adjust a high-order mode of the dielectric resonator 300 can be further adjusted. By improving the high-order mode of the dielectric resonator 300, eliminate interference frequency bands, such as second and third harmonics, can be more effectively suppressed, thereby improving performance of the dielectric resonator 300.

When the first dielectric block 10 includes only the annular part 12, the dielectric resonator 300 may form a TM (transverse magnetic) mode resonance.

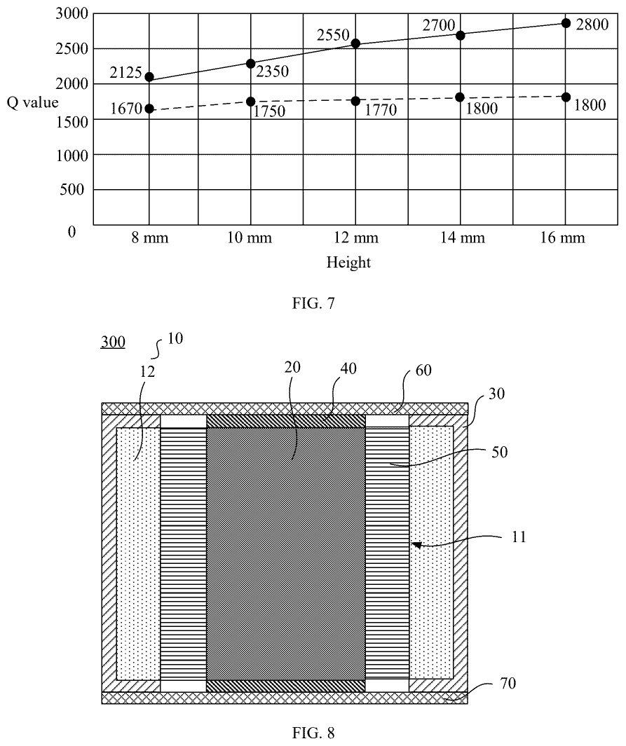

In some embodiments, as shown in FIG. 8, the dielectric resonator 300 further includes a fastening structure 50, which is located in the gap W and connects the annular part 12 to the second dielectric block 20.

In some examples, as shown in FIG. 8, the fastening structure 50 may fill up the gap W. In some other examples, the fastening structure 50 may alternatively occupy only a portion of space of the gap W.

In this embodiment of this application, the fastening structure 50 is disposed in the gap W, and the fastening structure 50 connects the annular part 12 to the second dielectric block 20. The fastening structure 50 secures a relative position relationship between the annular part 12 and the second dielectric block 20, preventing relative movement between the second dielectric block 20 and the annular part 12 that could cause damage to the second dielectric block 20 and the annular part 12 and interrupt normal operation of the dielectric resonator 300.

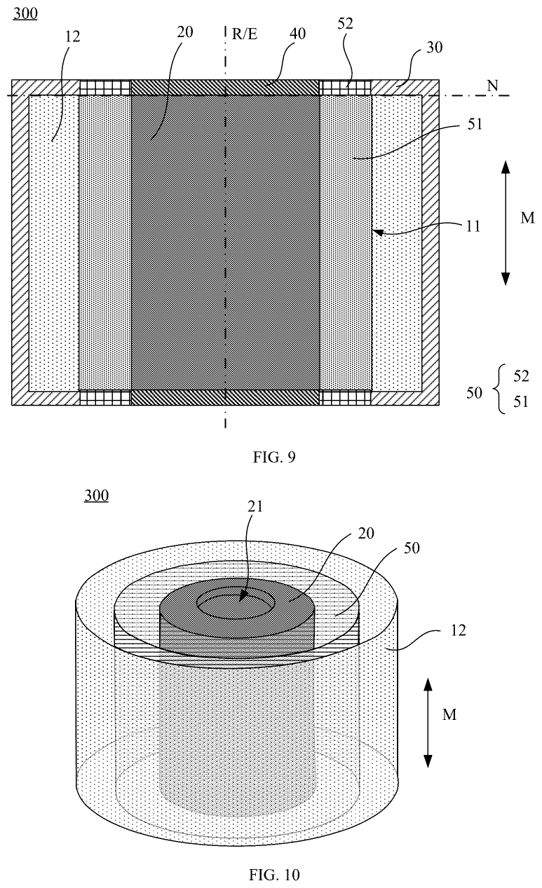

In some embodiments, as shown in FIG. 9, the fastening structure 50 may include an adhesive layer 51 and a third conductive layer 52.

The adhesive layer 51 is adhered to opposite surfaces of the annular part 12 and the second dielectric block 20. A material of the adhesive layer 51 is an insulating material. The third conductive layer 52 is located on a surface of the adhesive layer 51 other than a surface connecting the annular part 12 and the second dielectric block 20, and the third conductive layer 52 connects the first conductive layer 30 and the second conductive layer 40.

In some examples, a dielectric constant of the adhesive layer 51 is less than the dielectric constant of the first dielectric block 10.

For example, the dielectric constant of the adhesive layer 51 may be less than 10. For example, the dielectric constant of the adhesive layer 51 may be 1, 2, 4, 6, or the like.

In some examples, the adhesive layer 51 may include an inorganic material, for example, inorganic glue. In some other examples, the adhesive layer 51 may include an organic material, for example, resin.

In this embodiment of this application, the dielectric constant of the adhesive layer 51 is less than the dielectric constant of the first dielectric block 10, and the dielectric constant of the first dielectric block 10 is less than the dielectric constant of the second dielectric block 20. This creates a large difference between the dielectric constant of the adhesive layer 51 and the dielectric constant of the second dielectric block 20. Since the second dielectric block 20 is in direct contact with the adhesive layer 51 the dielectric resonator 300 exhibits a relatively high high-order mode during operation. This helps further filter out interference frequencies such as second and third harmonics of the resonance frequency, thereby improving performance of the dielectric resonator 300.

In some examples, a thickness of the adhesive layer 51 may range from 0.5 millimeters to 1 millimeter. For example, the thickness of the adhesive layer 51 may be 0.5 millimeters, 0.6 millimeters, 0.7 millimeters, 0.8 millimeters, 0.9 millimeters, 1 millimeter, or the like.

In this way, the thickness of the adhesive layer 51 is not small, so that the high-order mode of the dielectric resonator 300 can be effectively improved, and stability of a connection between the annular part 12 and the second dielectric block 20 can be enhanced. In addition, the thickness of the adhesive layer 51 is not excessively large, so that structural disposition of the first dielectric block 10 and the second dielectric block 20 in the dielectric resonator 300 is not affected. This helps ensure structural stability of the dielectric resonator 300.

In some examples, a material of the third conductive layer 52 may include metal, for example, silver or copper.

In some examples, a material of the third conductive layer 52 may be the same as that of the first conductive layer 30. In this case, the third conductive layer 52 and the first conductive layer 30 may be prepared at the same time. This helps simplify a preparation process of the dielectric resonator 300, reduce costs, and improve preparation efficiency.

In some other examples, a material of the third conductive layer 52 may be the same as that of the second conductive layer 40. In this case, the third conductive layer 52 and the second conductive layer 40 may be prepared at the same time. This helps simplify a preparation process of the dielectric resonator 300, reduce costs, and improve preparation efficiency.

In some other examples, a material of the third conductive layer 52 may be the same as that of the first conductive layer 30, and the material of the third conductive layer 52 may be the same as that of the second conductive layer 40. In this case, the first conductive layer 30, the second conductive layer 40, and the third conductive layer 52 may be prepared at the same time. This helps further simplify a preparation process of the dielectric resonator 300, reduce costs, and improve preparation efficiency.

A thickness of the third conductive layer 52 is not limited in embodiments of this application, and may be designed according to an actual requirement.

In this embodiment of this application, the fastening structure 50 includes the adhesive layer 51 and the third conductive layer 52. The adhesive layer 51 connects the annular part 12 to the second dielectric block 20, preventing relative movement between the second dielectric block 20 and the annular part 12 that could cause damage to the second dielectric block and the annular part and interrupt normal operation of the dielectric resonator. In addition, the third conductive layer 52 connects the first conductive layer 30 and the second conductive layer 40, helping simplify a structure of the dielectric resonator 300 and reduce costs.

In some other embodiments, the fastening structure 50 may be an insulation device. For example, the fastening structure 50 may include a polytetrafluoroethylene (Poly tetra fluoroethylene, PTFE for short) ring. Certainly, the fastening structure 50 may alternatively include only the adhesive layer 51, and does not include the third conductive layer 52.

In some embodiments, as shown in FIG. 9, at at least one end in an extension direction M of the mounting hole 11, the adhesive layer 51 is coplanar with the annular part 12 and the second dielectric block 20. FIG. 9 shows an example in which at at least one end in the extension direction M of the mounting hole 11, the adhesive layer 51, a surface of the annular part 12, and a surface of the second dielectric block 20 are on a same plane N.

It may be understood that, the “the adhesive layer 51 is coplanar with the annular part 12 and the second dielectric block 20” herein is not limited to a plane, and the adhesive layer 51, the surface of the annular part 12, and the surface of the second dielectric block 20 may be continuously located on a same arc surface or curved surface.

The “at at least one end in an extension direction M of the mounting hole 11, the adhesive layer 51 is coplanar with the annular part 12 and the second dielectric block 20” includes a case in which the adhesive layer 51 is coplanar with the annular part 12 and the second dielectric block 20 at one end in the extension direction M of the mounting hole 11, and the adhesive layer 51 is not coplanar with the annular part 12 and the second dielectric block 20 at the other end in the extension direction M of the mounting hole 11, and also includes a case in which the adhesive layer 51 is coplanar with the annular part 12 and the second dielectric block 20 at both ends in the extension direction M of the mounting hole 11.

In the dielectric resonator 300 provided in this embodiment of this application, at at least one end in the extension direction M of the mounting hole 11, the adhesive layer 51 is coplanar with the annular part 12 and the second dielectric block 20. This facilitates coupling between the third conductive layer 52 located on the adhesive layer 51, the first conductive layer 30 located on the annular part 12, and the second conductive layer 40 located on the second dielectric block 20, thereby helping simplify a structure of the dielectric resonator 300.

When the mounting hole 11 is a through hole, the extension direction M of the mounting hole 11 is a direction in which an opening at one end of the mounting hole 11 points to an opening at the other end. When the mounting hole 11 is a blind hole, the extension direction M of the mounting hole 11 is a direction in which a bottom wall of the mounting hole 11 points to an opening of the mounting hole 11.

In some embodiments, as shown in FIG. 9, an axis R of the mounting hole 11 coincides with an axis E of the second dielectric block 20.

In some examples, the mounting hole 11 may be a circular hole. In this case, the axis of the mounting hole 11 passes through a circle center of a cross section of the mounting hole 11, and is perpendicular to the cross section of the mounting hole 11. In some other examples, a cross section of the mounting hole 11 may be in a polygon shape. In this case, the axis of the mounting hole 11 may pass through a circle center of a circumscribed circle (or an inscribed circle) of the polygon, and is perpendicular to the cross section.

In some examples, the second dielectric block 20 may be in a cylinder shape. In this case, the axis of the second dielectric block 20 passes through a circle center of a cross section of the cylinder, and is perpendicular to the cross section of the cylinder. In some other examples, a cross section of the second dielectric block 20 may be in a polygon shape. In this case, the axis of the second dielectric block 20 may pass through a circle center of a circumscribed circle (or an inscribed circle) of the polygon, and is perpendicular to the cross section.

In this way, the second dielectric block 20 may be located at a central position of the mounting hole 11, allowing more electric fields to be concentrated in the second dielectric block 20. This further reduces a loss of the dielectric resonator 300 and increases a Q value of the dielectric resonator 300. In addition, locating the second dielectric block 20 at the central position of the mounting hole 11 helps achieve a more uniform magnetic field distribution outside the first dielectric block 10, thereby improving performance of the dielectric resonator 300.

In some embodiments, as shown in FIG. 10, the second dielectric block 20 is provided with a blind hole 21 at at least one end in the extension direction M of the mounting hole 11. It may be understood that, to clearly show the blind hole 21, the first conductive layer and the second conductive layer are not shown in FIG. 10.

In this embodiment of this application, a shape, a size, and a depth of the blind hole 21 are not limited, and may be designed according to an actual requirement. In some possible designs, the second dielectric block 20 may be provided with one blind hole 21 at one end in the extension direction M of the mounting hole 11. However, in some other possible designs, the second dielectric block 20 may alternatively be provided with a plurality of blind holes 21 at one end in the extension direction M of the mounting hole 11.

In some examples, the second dielectric block 20 may be provided with a blind hole 21 at one end in the extension direction M of the mounting hole 11, and provided with no blind hole 21 at the other end. In some other examples, the second dielectric block 20 may be provided with blind holes 21 at both ends in the extension direction M of the mounting hole 11.

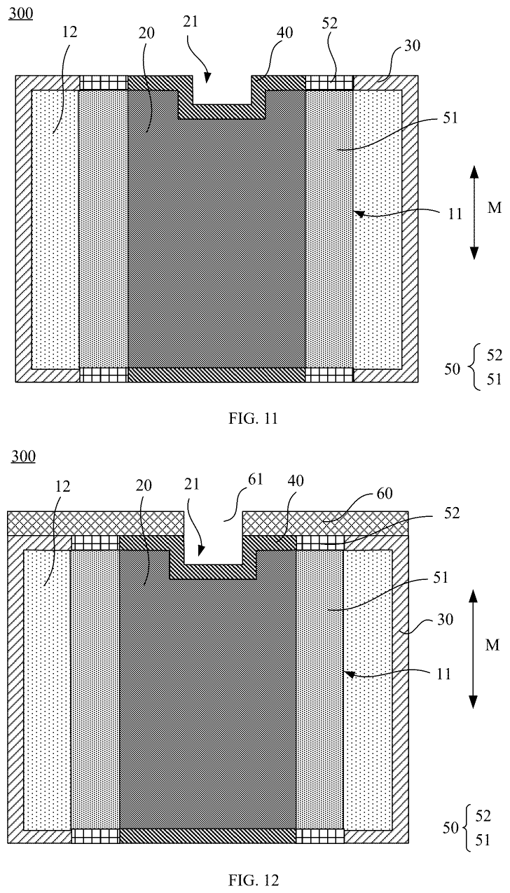

FIG. 11 is a diagram of a structure of the dielectric resonator 300 according to an embodiment of this application. As shown in FIG. 11, when the second dielectric block 20 is provided with the blind hole 21 at one end in the extension direction M of the mounting hole 11, the second conductive layer 40 further covers a side wall and a bottom wall of the blind hole 21.

In this embodiment of this application, the second dielectric block 20 is provided with the blind hole 21 at one end in the extension direction M of the mounting hole 11. The blind hole 21 can be used to fine-tune a resonance frequency of the dielectric resonator 300 after the dielectric resonator 300 is prepared, thereby increasing manufacturing field of the dielectric resonator 300.

For example, the resonance frequency of the dielectric resonator 300 may be fine-tuned by grinding the second conductive layer 40 on the bottom wall of the blind hole 21.

In some embodiments, as shown in FIG. 5 and FIG. 12, the dielectric resonator 300 further includes a first conductive cover 60. In the extension direction M of the mounting hole 11, the first conductive cover 60 is located on one side of the second dielectric block 20, and the first conductive cover 60 connects the first conductive layer 30 and the second conductive layer 40.

For example, a material of the first conductive cover 60 may include metal, for example, iron. In this embodiment of this application, neither a thickness nor a size of the first conductive cover 60 is limited, provided that the first conductive cover 60 can be connected to the first conductive layer 30 and the second conductive layer 40.

In some examples, the first conductive cover 60 may be connected to the first conductive layer 30 through soldering, and the first conductive cover 60 may be connected to the second conductive layer 40 through soldering.

In the dielectric resonator 300 provided in this embodiment of this application, the first conductive cover 60 is disposed on one side of the second dielectric block 20 in the extension direction M of the mounting hole 11. The first conductive cover 60 electrically connects the first conductive layer 30 and the second conductive layer 40, while securing a relative position relationship between the first dielectric block 10 and the second dielectric block 20. This helps enhance structural stability and manufacturing yield of the dielectric resonator 300 provided in this embodiment of this application.

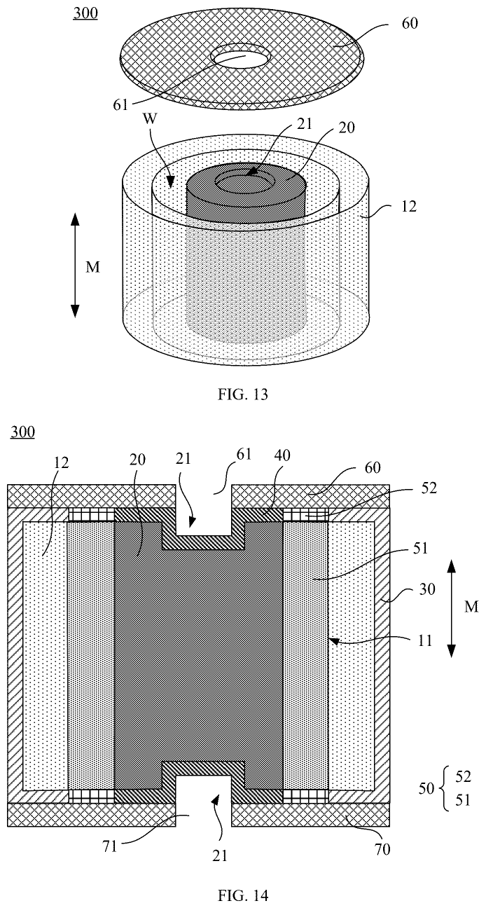

FIG. 13 is an exploded diagram of the dielectric resonator 300 according to an embodiment of this application, where the first conductive layer and the second conductive layer are not shown. As shown in FIG. 13, when the first conductive cover 60 is disposed on one side of the second dielectric block 20 in the extension direction M of the mounting hole 11, the fastening structure 50 may not be disposed in the gap W between the annular part 12 and the second dielectric block. This helps simplify a structure of the dielectric resonator 300 and reduce costs.

In some examples, as shown in FIG. 12, when the blind hole 21 is provided at an end that is of the second dielectric block 20 and that is close to the first conductive cover 60, the first conductive cover 60 includes a first opening 61, and the blind hole 21 is exposed from the first opening 61. In this way, it is convenient to subsequently adjust a frequency of the dielectric resonator 300 by using the blind hole 21.

In this embodiment of this application, neither a shape nor a size of the first opening 61 is limited, provided that the blind hole 21 can be exposed. For example, the first opening 61 may be a circular opening.

In some other embodiments, as shown in FIG. 5 and FIG. 14, the dielectric resonator 300 further includes a second conductive cover 70. In the extension direction M of the mounting hole 11, the second conductive cover 70 is located on the other side of the second dielectric block 20, and the second conductive cover 70 connects the first conductive layer 30 and the second conductive layer 40.

For example, a material of the second conductive cover 70 may include metal, for example, iron. In this embodiment of this application, neither a thickness nor a size of the second conductive cover 70 is limited, provided that the second conductive cover 70 can be connected to the first conductive layer 30 and the second conductive layer 40.

In some examples, the first conductive cover 60 and the second conductive cover 70 may be made of a same material. In this case, the first conductive cover 60 and the second conductive cover 70 have a same resistance value. This helps reduce a loss when a current flows through the first conductive cover 60 and the second conductive cover 70.

In some examples, the second conductive cover 70 may be connected to the first conductive layer 30 through soldering, and the second conductive cover 70 may be connected to the second conductive layer 40 through soldering.

In the dielectric resonator 300 provided in this embodiment of this application, the second conductive cover 70 is disposed on the other side of the second dielectric block 20 in the extension direction M of the mounting hole 11. Both the first conductive cover 60 and the second conductive cover 70 electrically connect the first conductive layer 30 and the second conductive layer 40, while securing the relative position relationship between the first dielectric block 10 and the second dielectric block 20. This helps further enhance structural stability and manufacturing yield of the dielectric resonator 300 provided in this embodiment of this application.

In some examples, as shown in FIG. 14, when the blind hole 21 is provided at an end that is of the second dielectric block 20 and that is close to the second conductive cover 70, the second conductive cover 70 includes a second opening 71, and the blind hole 21 is exposed from the second opening 71. In this way, it is convenient to subsequently adjust a frequency of the dielectric resonator 300 by using the blind hole 21.

In this embodiment of this application, neither a shape nor a size of the second opening 71 is limited, provided that the blind hole 21 can be exposed. For example, the second opening 71 may be a circular opening.

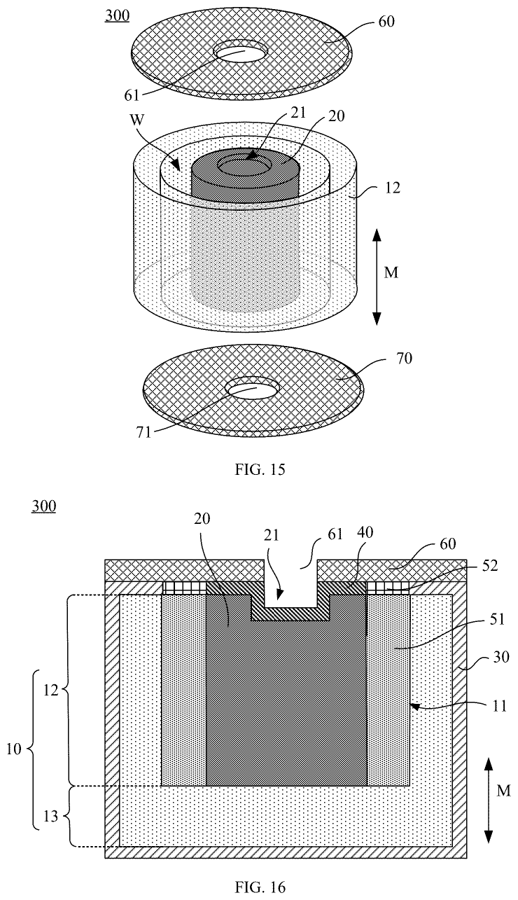

FIG. 15 is an exploded diagram of the dielectric resonator 300 according to an embodiment of this application, where the first conductive layer and the second conductive layer are not shown. As shown in FIG. 15, the first conductive cover 60 is disposed on one side of the second dielectric block 20 in the extension direction M of the mounting hole 11. When the second conductive cover 70 is disposed on the other side of the second dielectric block 20, the fastening structure 50 may not be disposed in the gap W between the annular part 12 and the second dielectric block. This helps simplify a structure of the dielectric resonator 300 and reduce costs.

In some embodiments, as shown in FIG. 16, the first dielectric block 10 further includes a block-shaped part 13 connected to the annular part 12, and the block-shaped part 13 covers an opening at an end of the mounting hole 11. In this case, the mounting hole 11 is a blind hole.

For example, the annular part 12 and the block-shaped part 13 may be an integral part, in other words, the annular part 12 and the block-shaped part 13 are made of a same material, and there is no spacing interface between the annular part 12 and the block-shaped part 13.

In some examples, in the extension direction M of the mounting hole 11, a size of the annular part 12 may be greater than a size of the block-shaped part 13. In some other examples, in the extension direction M of the mounting hole 11, a size of the annular part 12 may alternatively be equal to a size of the block-shaped part 13. In some other examples, in the extension direction M of the mounting hole 11, a size of the annular part 12 may alternatively be less than a size of the block-shaped part 13.

When the first dielectric block 10 includes the block-shaped part 13, the first conductive layer 30 may alternatively be located on a surface of the block-shaped part 13 other than a surface opposite to the second dielectric block 20.

In this embodiment of this application, although the mounting hole is a blind hole, the absence of a conductive layer on a hole wall of the mounting hole avoids a significant loss typically associated with current flowing through plated blind holes in conventional designs. In the dielectric resonator 300 provided in this embodiment of this application, the second dielectric block 20 that is located in the mounting hole 11 and that has a higher dielectric constant may concentrate more electric fields in the dielectric resonator 300 in the second dielectric block 20, to generate an induced current in the second dielectric block 20. Due to the inherent high Q value characteristic of dielectric materials, the second dielectric block 20 has a relatively small impedance. As the induced current flows through the second dielectric block 20, a loss generated by the dielectric resonator 300 may be relatively small, thereby effectively increasing the Q value of the dielectric resonator 300.

An embodiment of this application provides a dielectric filter, and the dielectric filter includes the dielectric resonator 300 provided in any one of the foregoing embodiments.

The dielectric filter provided in this embodiment of this application may be used in an active antenna element (active antenna element, AAU), and used as a filter of a radio frequency unit. The dielectric filter may also be used in a radio remote unit (radio remote unit, RRU), to form a duplexer unit.

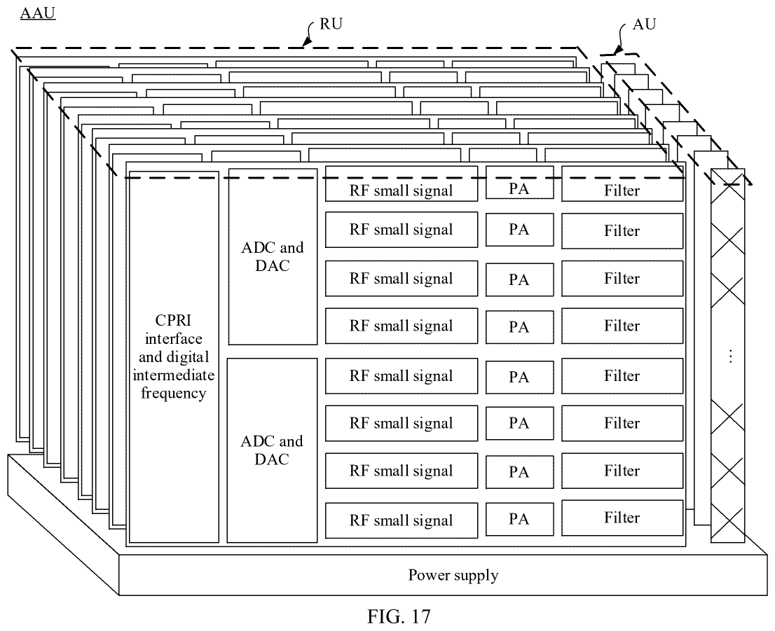

As shown in FIG. 17, a radio frequency unit RU of an active antenna element AAU may include a CPRI (Common Public Radio Interface, common public radio interface) interface and a digital intermediate frequency module, an ADC (analog to digital converter) module and a DAC (digital to analog converter) module, a PA (power amplifier, power amplifier) module, and a filter. The ADC and the DAC module are configured to: convert a digital baseband signal sent by the CPRI interface and the digital intermediate frequency module into an RF (Radio Frequency, radio frequency) small signal, and send the RF small signal to the PA module. The PA module amplifies the RF small signal to form a radio frequency signal, and transmits the radio frequency signal to the filter. The radio frequency signal is filtered by the filter, and then sent by the antenna AU to another base station or user equipment. The active antenna element AAU further includes a power supply, to supply power to the radio frequency unit.

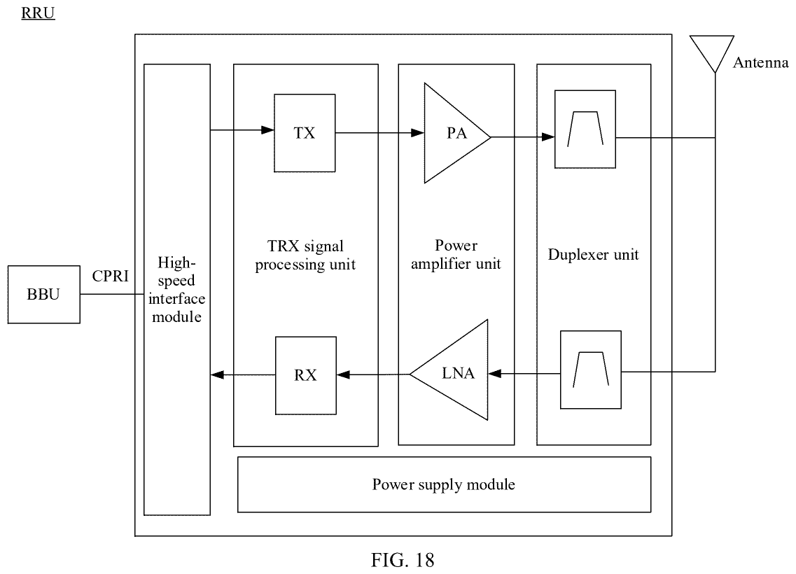

As shown in FIG. 18, the radio remote unit RRU may include a high-speed interface module, a TRX signal processing unit, a power amplifier unit, a duplexer unit, an antenna, and a power supply module. The high-speed interface module is configured to connect to a baseband unit BBU. A signal output by the baseband unit BBU can be sequentially transmitted to the antenna through the TRX signal processing unit, the power amplifier unit, and the duplexer unit, and then to another base station or user equipment. A signal received by the antenna can be sequentially transmitted to the baseband unit BBU through the duplexer unit, the power amplifier unit, and the TRX signal processing unit. In FIG. 18, TX represents data sending, RX represents data receiving, PA represents a power amplifier, and LNA represents a low noise power amplifier. The power supply module supplies power to the foregoing plurality of units.

It may be understood that, a technical effect that can be implemented by the dielectric filter provided in this embodiment of this application is the same as the technical effect that can be achieved by the dielectric resonator provided in any one of the foregoing embodiments.

An embodiment of this application further provides a communication device. The communication device includes the dielectric filter (or the dielectric resonator 300).

It should be understood that the communication device may be a network device, for example, may be any device having a wireless transceiver function. The device includes but is not limited to: an evolved NodeB (evolved NodeB, eNB), a radio network controller (Radio Network Controller, RNC), a NodeB (NodeB, NB), a base station controller (Base Station Controller, BSC), a base transceiver station (Base Transceiver Station, BTS), a home base station (for example, a Home evolved NodeB, or a Home NodeB, HNB), a baseband unit (BaseBand Unit, BBU), an access point (Access Point, AP) in a wireless fidelity (Wireless Fidelity, Wi-Fi) system, a wireless relay node, a wireless backhaul node, a transmission point (transmission point, TP), or a transmission and reception point (transmission and reception point, RP), or the like. Alternatively, the device may be a gNB or a transmission point (TRP or TP) in a 5G system like an NR system, or one or a group of antenna panels (including a plurality of antenna panels) of a base station in the 5G system. Alternatively, the device may be a network node that constitutes a gNB or a transmission point, for example, a baseband unit (BBU) or a distributed unit (distributed unit, DU).

Alternatively, the communication device may be a terminal device. The terminal device may also be referred to as user equipment (user equipment, UE), an access terminal, a subscriber unit, a subscriber station, a mobile station, a remote station, a remote terminal, a mobile device, a user terminal, a terminal, a wireless communication device, a user agent, or a user apparatus. The terminal device in embodiments of this application may be a mobile phone (mobile phone), a tablet computer (Pad), a computer having a wireless transceiver function, a virtual reality (virtual reality, VR) terminal device, an augmented reality (augmented reality, AR) terminal device, a wireless terminal in industrial control (industrial control), a wireless terminal in self-driving (self-driving), a wireless terminal in telemedicine (remote medical), a wireless terminal in a smart grid (smart grid), a wireless terminal in transportation safety (transportation safety), a wireless terminal in a smart city (smart city), a wireless terminal in a smart home (smart home), or the like. An application scenario is not limited in embodiments of this application.

It may be understood that, a technical effect that can be implemented by the communication device provided in this embodiment of this application is the same as the technical effect that can be achieved by the dielectric resonator provided in any one of the foregoing embodiments.

In the descriptions of this specification, the described specific features, structures, materials, or characteristics may be combined in a proper manner in any one or more of embodiments or examples.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A dielectric resonator, comprising:
a first dielectric block and a second dielectric block, wherein the first dielectric block has a mounting hole, and the second dielectric block in the mounting hole; and a dielectric constant of the second dielectric block is greater than a dielectric constant of the first dielectric block;
a first conductive layer, on at least a portion of a surface of the first dielectric block other than a surface opposite to the second dielectric block; and
a second conductive layer, on at least a portion of a surface of the second dielectric block other than a surface opposite to the first dielectric block, wherein the second conductive layer is coupled to the first conductive layer.

2. The dielectric resonator according to claim 1, wherein the first dielectric block includes an annular part, the annular part is around a periphery of the second dielectric block, and there is a gap between the annular part and the second dielectric block.

3. The dielectric resonator according to claim 2, further comprising:
a fastening structure, in the gap and connecting the annular part to the second dielectric block.

4. The dielectric resonator according to claim 3, wherein the fastening structure includes:
an adhesive layer, wherein the adhesive layer is between opposite surfaces of the annular part and the second dielectric block, and a material of the adhesive layer is an insulating material; and
a third conductive layer, on a surface of the adhesive layer other than a surface connecting the annular part and the second dielectric block, wherein the third conductive layer connects the first conductive layer and the second conductive layer.

5. The dielectric resonator according to claim 4, wherein a dielectric constant of the adhesive layer is less than the dielectric constant of the first dielectric block.

6. The dielectric resonator according to claim 4, wherein at at least one end in an extension direction of the mounting hole, the adhesive layer is coplanar with the annular part and the second dielectric block.

7. The dielectric resonator according to claim 1, wherein the second dielectric block is includes a blind hole at at least one end in an extension direction of the mounting hole.

8. The dielectric resonator according to claim 1, further comprising a first conductive cover, the first conductive cover is on one side of the second dielectric block in an extension direction of the mounting hole, and the first conductive cover connects the first conductive layer and the second conductive layer.

9. The dielectric resonator according to claim 8, wherein in response to a blind hole being at an end that is of the second dielectric block and that is close to the first conductive cover, the first conductive cover includes a first opening, and the blind hole is exposed from the first opening.

10. The dielectric resonator according to claim 8, further comprising a second conductive cover, the second conductive cover is on an other side of the second dielectric block in the extension direction of the mounting hole, and the second conductive cover connects the first conductive layer and the second conductive layer.

11. The dielectric resonator according to claim 10, wherein in response to a blind hole being at an end that is of the second dielectric block and that is close to the second conductive cover, the second conductive cover includes a second opening, and the blind hole is exposed from the second opening.

12. The dielectric resonator according to claim 2, further comprising a block-shaped part connected to the annular part, and the block-shaped part covers an opening at an end of the mounting hole.

13. The dielectric resonator claim 1, wherein an axis of the mounting hole coincides with an axis of the second dielectric block.

14. A dielectric filter, comprising a plurality of dielectric resonators, wherein each of the plurality of dielectric resonators comprises:
a first dielectric block and a second dielectric block, wherein the first dielectric block has a mounting hole, and the second dielectric block is in the mounting hole; and a dielectric constant of the second dielectric block is greater than a dielectric constant of the first dielectric block;
a first conductive layer, on at least a portion of a surface of the first dielectric block other than a surface opposite to the second dielectric block; and
a second conductive layer, on at least a portion of a surface of the second dielectric block other than a surface opposite to the first dielectric block, wherein the second conductive layer is coupled to the first conductive layer.
